(19) United States
(12) Patent Application Publication
(10) Pub. No.: US 2019/0263177 A1
(43) Pub. Date: Aug. 29, 2019

(54) NON-PNEUMATIC ELASTOMERIC TIRE WITH CROSSED SPOKE SIDEWALLS

(71) Applicant: LANXESS Solutions US Inc., Shelton, CT (US)

(72) Inventor: Ian LASKOWITZ, Bantam, CT (US)

(73) Assignee: LANXESS Solutions US Inc., Shelton, CT (US)

(21) Appl. No.: 16/407,979

(22) Filed: May 9, 2019

Related U.S. Application Data
(63) Continuation of application No. 15/474,081, filed on Mar. 30, 2017, now abandoned.
(60) Provisional application No. 62/337,986, filed on May 18, 2016.

(51) Int. Cl. B60C 7/10; B60C 7/12; B60C 7/18; B60C 11/00

(52) U.S. Cl. CPC B60C 7/10; B60C 7/125; B60C 7/12; B60C 2007/146; B60C 11/00; B60C 2007/107; B60C 7/18

(57) ABSTRACT

A non-pneumatic tire with an annular body of resilient elastomeric material comprises circumferential web members supported by a plurality of circumferentially spaced crossed spoke pairs. The thickness and angle of the spokes in each crossed spoke pair varies.

This application is a continuation of U.S. patent application Ser. No. 15/474,081 filed Mar. 30, 2017, with the same title, which claims the right of priority to U.S. Provisional Patent Application Ser. No. 62/337,986, filed May 18, 2016, the contents of which are hereby incorporated by reference in their entirety.

Non-pneumatic tires, comprising sidewalls having a series of crossed spoke pairs supporting circumferential members that allow for increased deflection and higher torque stiffness, which tires can be made in a wide range of sizes, capable of carrying extreme loads, and suitable for a variety of uses are provided.

### BACKGROUND

Non-pneumatic tires, that is, tires that are made of a solid material and do not require inflation to be operational, are well known. Non-pneumatic tires do not have the risks associated with tire failures, blowouts, or punctures associated with pneumatic tires. Non-pneumatic tires are available in a variety of sizes and are used in a variety of applications, e.g., small non-pneumatic tires may be used for shopping carts, dollies for moving furniture or equipment, etc., large non-pneumatic tires may be found on mining and construction equipment and the like, and non-pneumatic tires of various sizes may be found on forklifts, carriages, carts, wagons, other people moving vehicles, other freight moving vehicles etc.

Off-the-road (OTR) vehicles, also known as off-highway vehicles, are used in rugged terrain for mining, excavation, construction, military applications, and other heavy industrial applications. OTR vehicles include tractors, trucks, loaders, dozers, graters, excavators, etc., and may have operational weights as high as 380 to 460 tons. These applications require that each tire have properties such as being puncture-proof, able to carry relatively heavy loads, and good resistance to wear and tear. Typically, such OTR vehicles have several inflatable tires made of rubber, but conventional inflatable tires generally have short operational life spans of about six months. Further, the typical rugged operating environment for OTR vehicles exposes the tires to possible failures, such as punctures, blowouts, tears, and separation of the tire from the rim. The time and cost to maintain such OTR vehicles increases because the inflatable tires need to be replaced due to normal wear and tire failure. While improvements in the durability of such inflatable tires continue to be made, such tires are still exposed to wear and failure.

OTR vehicles represent just one of the many applications where the need still exists for tires that overcome the shortcomings of conventional inflatable tires. It has been found that a non-pneumatic tire structure having circumferential webs and opposing sidewalls with crossed spoke pairs connecting and supporting the circumferential webs allows for greater stability at higher deflections. Moreover, depending on the end use, the design can be adjusted for added deflection.

### SUMMARY OF THE INVENTION

The present invention provides a non-pneumatic tire having an annular elastomeric body comprising a central web, a middle circumferential web member, an outer circumferential web member and opposing sidewalls, wherein each sidewall comprises:

a plurality of first outer spoke members, each of which is inclined at a selected angle from the outer circumferential member; and a plurality of second outer spoke members, each of which is inclined at a selected angle from the outer circumferential member in a direction opposite to that of the first outer spoke members; wherein each first outer spoke member intersects with a second outer spoke member at a spoke intersection between the middle circumferential web member and the outer circumferential web member to create a crossed spoke pair.

The first and second outer spoke members each have an inside spoke end located between the spoke intersection and the middle circumferential member and an outside spoke end located between the spoke intersection and the outer circumferential member. The angle and/or thickness of the first and second outer spoke members between the spoke intersection and the middle circumferential member may be different than the angle and/or thickness of the spoke members between the outer circumferential member to the spoke intersection.

In certain embodiments of the present invention, a second “inner” layer of spokes is also present. In such embodiments, the non-pneumatic tire also comprises a plurality of first inner spoke members, each of which is inclined at a selected angle from the middle circumferential member to an inner circumferential web member; and a plurality of second inner spoke members, each of which are inclined at a selected angle from the middle circumferential web member to the inner circumferential web member in a direction opposite to that of the first inner spoke members.

In some embodiments wherein the tire comprises a second inner layer of spokes, the first and second inner spoke members form a “V” pattern.

In some embodiments wherein the tire comprises a second inner layer of spokes, each first inner spoke member intersects a second inner spoke member at a spoke intersection between the middle circumferential web member and the inner circumferential web member, and the first and second inner spoke members each have an inside spoke end located between the spoke intersection and the middle circumferential member and an outside spoke end located between the spoke intersection and the inner circumferential member. The angle and/or thickness of the first and second inner spoke members between the spoke intersection and the middle circumferential member may be different than the angle and/or thickness of the spoke members between the inner circumferential member and the spoke intersection.

The thickness of inside spoke ends of the outer spoke members may be the same as or different from the outside spoke ends of the outer spoke members. For example, in some embodiments the inside spoke ends of the outer spoke members are thicker than the outside spoke ends of the outer spoke members, and in some embodiments the inside spoke ends of the outer spoke elements are thinner than the outside spoke ends of the outer spoke members.

Likewise, the thickness of the inside spoke ends of the inner spoke members may be the same as or different from the outside spoke ends of the inner spoke members. For example, in some embodiments the inside spoke ends of the inner spoke members are thicker than the outside spoke ends of the inner spoke members, and in some embodiments the inside spoke ends of the inner spoke members are thinner than the outside spoke ends of the inner spoke members.

The angle of the first and second outer spoke members and/or the first and second inner spoke members may be varied to suit the intended end use of the tire.

In certain embodiments the outer circumferential member has tread grooves embedded or molded into the outer circumferential member. The tire may be molded from a single elastomeric material, such as for example, polyurethane. Alternatively, the tire may be molded from at least two different durometer materials in the same mold.

### BRIEF DESCRIPTION OF THE DRAWINGS

FIG. 1 depicts a close up sidewall view of a portion of a tire having two-layer crossed spoke configuration on a sidewall according to one embodiment of the present invention.

FIG. 2 shows a sidewall view of a tire according to an embodiment of the present invention having a one layer crossed spoke configuration.

FIG. 3 depicts a sidewall view of a tire according to an embodiment of the present invention having a two layer spoke configuration. The outer spoke layer is a crossed spoke pair “X” configuration and the inner most layer is a “V” configuration.

FIG. 4 depicts a sidewall view of a tire according to an embodiment of the present invention having a two layer crossed spoke configuration.

FIG. 5 shows a sidewall view of a treaded tire according to an embodiment of the present invention having outer crossed spoke pairs and inner cross spoke pairs.

FIG. 6 depicts a sidewall view of a treaded tire according to an embodiment of the present invention having 45 crossed spoke pairs.

FIG. 7 illustrates a portion of a tire according an embodiment of the present invention wherein spokes on one sidewall, shown in solid lines, are offset or staggered relative the spokes on the opposing sidewall, shown in dotted lines.

FIG. 8 depicts a sidewall view of a tire according to an embodiment of the present invention in which the inside spoke ends are of a different thickness than the outside spoke ends.

FIG. 9 depicts a sidewall view of a tire according to an embodiment of the present invention in which the inside spoke ends are of a different thickness than the outside spoke ends.

FIG. 10 depicts a sidewall view of a tire according to an embodiment of the present invention in which the outside spokes (4,5) are thinner than the inside spokes (7,8)

FIG. 11 depicts a sidewall view of a tire according to an embodiment of the present invention in which the outside spokes (4,5) are thicker than the inside spokes (7,8).

### DETAILED DESCRIPTION OF THE INVENTION

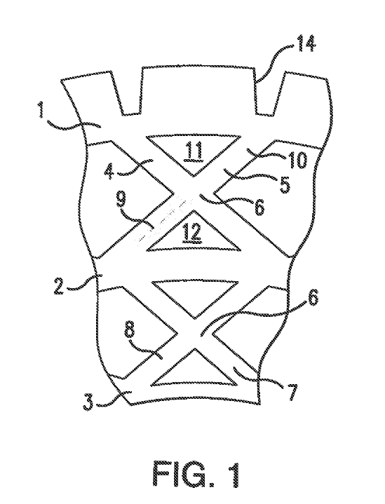

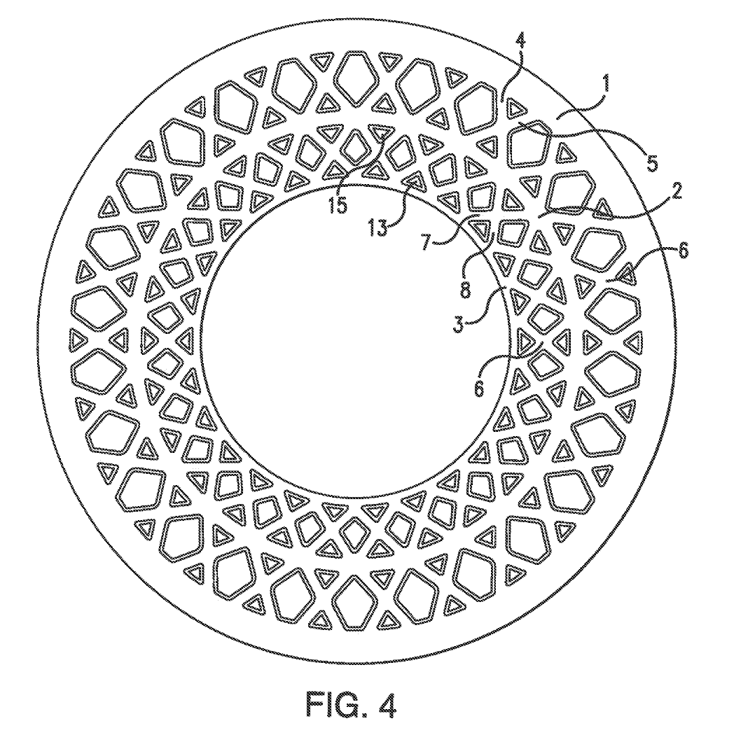

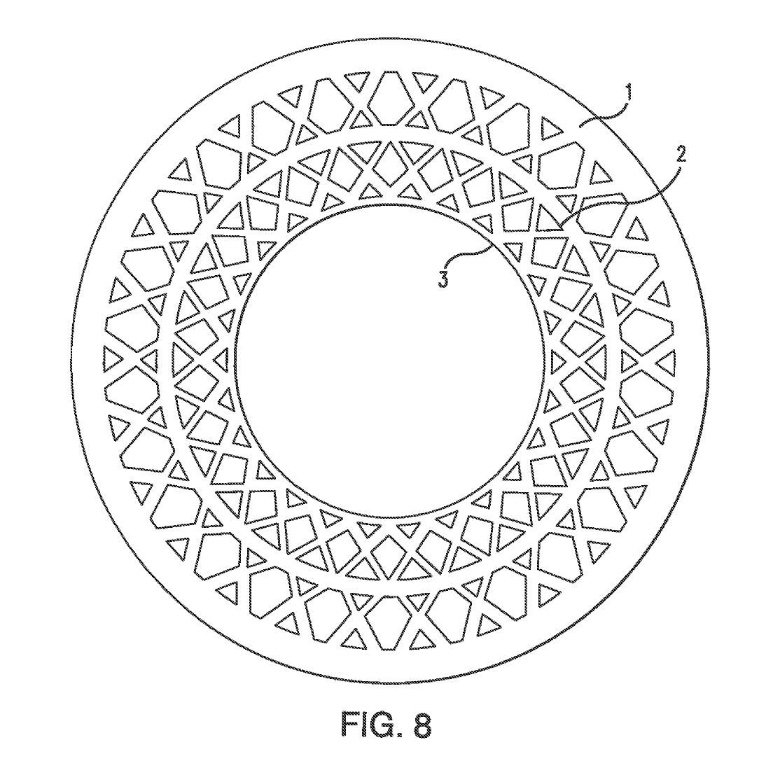

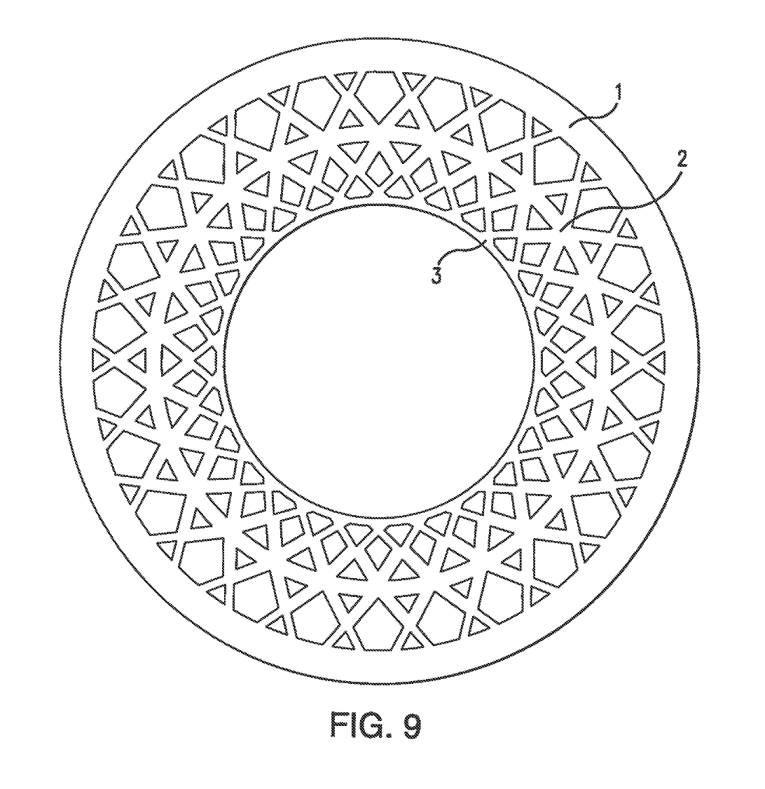

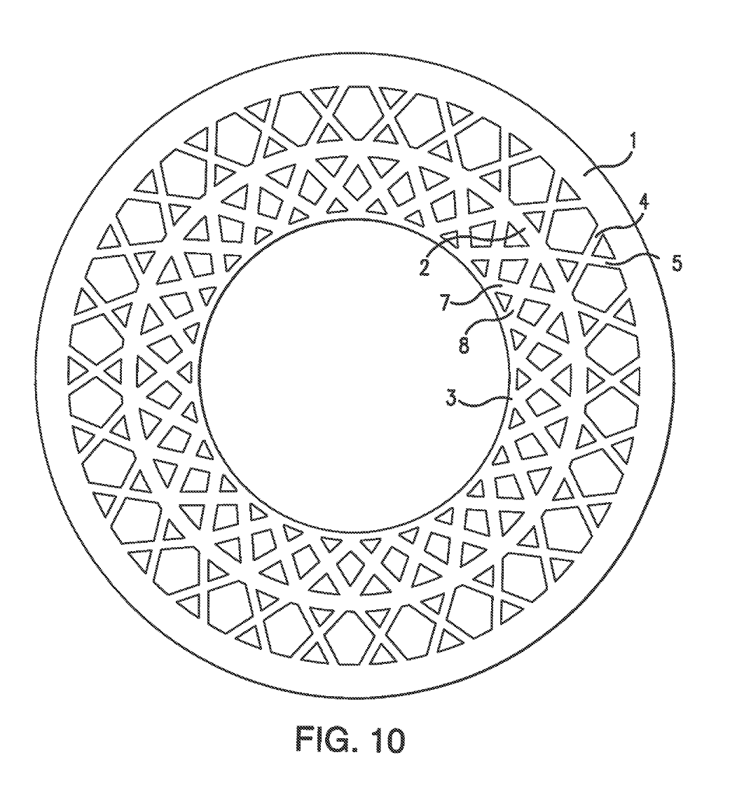

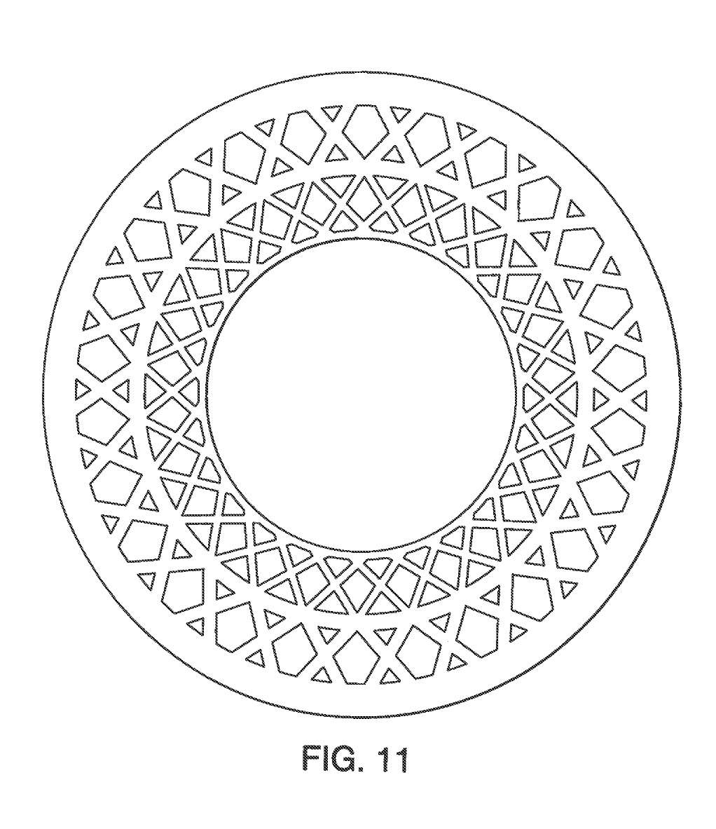

FIGS. 1-11 illustrate certain embodiments of the present invention. As shown, various sidewall views depict crossed spoke pairs which extend in a radial direction from the center axis of the exemplary tire, which tire is mountable to a rim, not shown. The reference numerals relate to the same element in each figure and are not necessarily repeated in the figures for each iteration.

The non-pneumatic tire of the present invention is designed to operate around a central tire axis, i.e., the tire is rotatable about a central axis. The annular body of the tire may be mounted on an outer cylindrical surface of a wheel rim member (not shown). The wheel rim member can be constructed from a variety of materials including steel, aluminum, fiberglass reinforced plastic, and other materials as well. The annular tire is preferably made of a resilient elastomeric material, such as polyurethane, and, as seen in FIG. 1, has an outer circumferential web (1) at the outer periphery thereof on which an optional tread (14) may be mounted or structurally incorporated. The annular body is provided with a middle circumferential web (2), and in many embodiments, the annular body if also provided with an inner circumferential web (3).

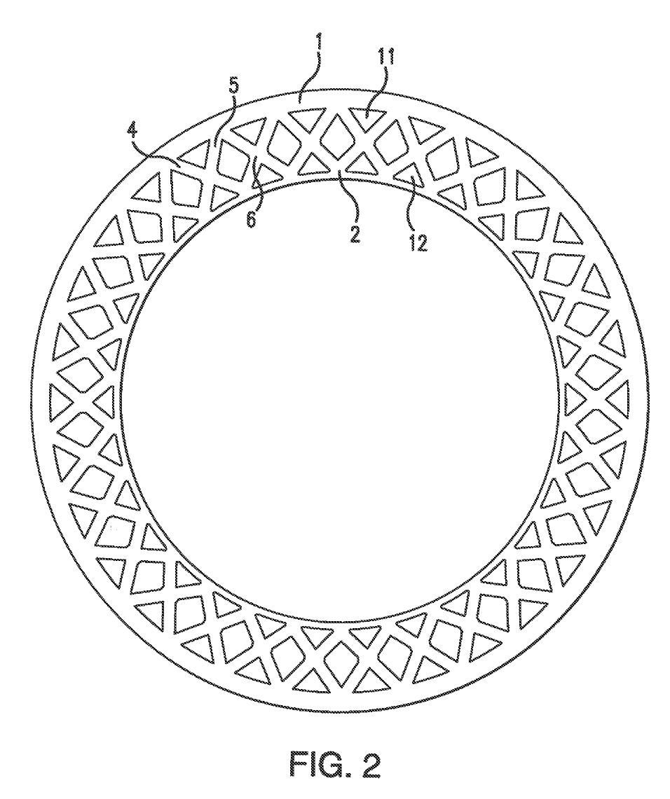

In embodiments with one layer of crossed spoke pairs, such as can be seen in FIG. 2, the middle circumferential web (2) is at the tires inner periphery, which may be adhered to or otherwise fastened to the outer cylindrical surface of a wheel rim member. The middle circumferential web (2) is coaxial to, and coextensive with, the outer circumferential web member (1). In embodiments with multiple spoke layers, such as can be seen in FIGS. 1, 3-6 and 8-11, the annular tire body is also provided with an inner circumferential web (3) at its inner periphery which may be adhered to or otherwise fastened to the outer cylindrical surface of a wheel rim member. The inner circumferential web (3) is coaxial to, and coextensive with, the middle circumferential web (2) member and the outer circumferential web member (1).

The outer circumferential web (1) is supported and cushioned by a plurality of circumferentially spaced-apart spoke members (4, 5) which intersect at a spoke intersection (6) to form crossed spoke pairs. They are provided on both sidewalls of a generally planar central web member, which separates the two sidewalls. The various spoke members are connected at their radially inside spoke ends (9) to the middle circumferential web member (2) and at their radially outside spoke ends (10) to the outer circumferential web member (1).

The central web member is positioned midway between the axial ends of the outer, middle and inner circumferential web (1, 2, and 3) in embodiments with multiple spoke layers, and between the axial ends of the outer and middle circumferential web (1, 2) in embodiments with a single spoke layer. In a multiple spoke layer tire, the central web member is connected at its outer periphery to the outer circumferential web member (1) and connected at its inner periphery to the inner circumferential web member (3); in a single layer tire, it is connected at its outer periphery to the outer circumferential web member (1) and connected at its inner periphery to the middle circumferential web member (2).

One embodiment the present invention, FIG. 2, provides a non-pneumatic tire having middle (2) and outer circumferential web (1) members. On each sidewall between the middle (2) and outer circumferential web (1) members are a series of first (4) and second (5) outer spoke members. Each set of first (4) and second (5) spoke members intersect at a spoke intersection (6) forming a crossed spoke pair.

Each first outer spoke member (4) originates at the outer circumferential member (1) and is inclined at a selected angle from the radial plane towards a middle circumferential member (2). Each second outer spoke member (5) originates at the outer circumferential member (1) and is inclined at a selected angle from the radial plane towards a middle circumferential member (2). The second outer spoke member (5) is inclined in the opposite direction from the first outer spoke member (4). Each first outer spoke member (4) crosses a second outer spoke member (5) at a spoke intersection (6) located between the outer circumferential web (1) and the middle circumferential web (2). The angle and/or thickness of the spokes between the spoke intersection (6) and the middle circumferential web (2) member may differ from the angle and/or thickness of the spokes from the outer circumferential member (1) to the spoke intersection (6).

In certain embodiments the tire also comprises an inner circumferential web, e.g., FIG. 1, 3-6 and 8-11. In such embodiments, a plurality of first inner spoke members (7) originate at the middle circumferential member (2) and are inclined at a selected angle from the radial plane towards an inner circumferential web (3) member. A plurality of second inner spoke members (8) originate at the middle circumferential member (2) and are inclined at a selected angle from the radial plane towards an inner circumferential web (3) member. The second inner spoke members (8) are inclined in the opposite direction from the first inner spoke members (7). Each first (7) and second inner spoke member (8) is of approximately equal length. The thickness of the first inner spoke members (7) may be the same as the thickness of the second inner spoke members (8) or the thickness may vary between spoke members.

Each first and second outer spoke member (4, 5) has an inside spoke end (9) and an outside spoke end (10). The outside spoke end (10) originates at the outer circumferential member (1) and is inclined at a selected angle from the radial plane towards a middle circumferential member (2).

Each first outer spoke member (4) crosses and intersects with a second outer spoke member (5) at a spoke intersection (6) between the middle circumferential web (2) member and the outer circumferential web (1) member. In many embodiments the thickness and angle of the inner and outer ends of the outer spoke members are different.

In certain embodiments, all first outer spoke members (4) and all second outer spoke members (5) are of approximately equal length and intersect at a spoke intersection (6) between the middle circumferential member and the outer circumferential member. In certain embodiments, all first inner spoke members and all second inner spoke members may also be of approximately equal length.

The intersection of a first outer spoke member (4) and second outer spoke member (5) creates a crossed spoke pair resulting in a generally “X” shaped crossed spoke configuration and a generally triangular shaped cell (11) above each spoke intersection (6) and a generally triangular shaped cell (12) below each spoke intersection. The generally triangular shaped cells (11) above the spoke intersection (6) are bounded by surfaces of the outside end (10) of each first (4) and second outer spoke member (5) and the outer circumferential web (1). The generally triangular shaped cells (12) below the spoke intersection (6) are bounded by the inside end (9) of each first (4) and second (5) outer spoke members and the middle circumferential web (2). Between each crossed spoke pair configuration is an open generally quadrangular open cell. Depending on the spacing between the crossed spoke pairs, the open cell between the crossed spoke pairs can be a generally four, five or six sided open cell. Often the thickness and/or the angle of the inner ends of the first and second spoke members are slightly different than the outer ends of the first and second spoke members, and the generally triangular shaped cells below the spoke intersection (6) will often have different angles in comparison to the generally triangular shaped cells above the spoke intersection.

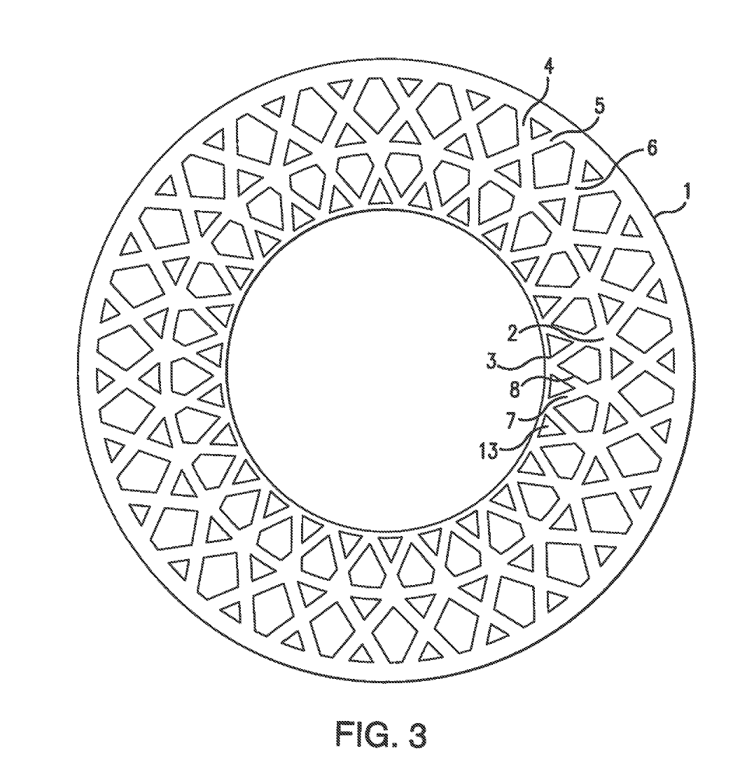

In certain aspects of the invention, such as can be seen in FIG. 3, each pair of a first (7) and second (8) inner spoke members create a “V” configuration resulting in an open generally triangular cell (13) which is bounded by a surface of a first inner spoke (7), a second inner spoke (8) and the inner circumferential web (3). Between each “V” configuration is a generally triangular open cell although depending on the spacing between the “V” configurations the open cell between the “V” configured spokes can be a generally four, five or six sided open cell.

In certain aspects of the invention, such as can be seen in FIG. 1, 4-6 and 8-11, the intersection of a first and a second inner spoke member (7, 8) create a generally “X” shaped crossed spoke pair resulting in a generally triangular shaped middle cell (13) below each spoke intersection (6) and a generally triangular shaped inner cell (15) above each spoke intersection.

The generally triangular shaped middle cells (13) below the spoke intersection (6) are bounded by surfaces of the outside end of each first (7) and second inner spoke member (8) and the inner circumferential web (3). The generally triangular shaped inner cells (15) above the spoke intersection (6) are bounded by the inside end (9) of each first (7) and second inner spoke member (8) and the middle circumferential web (2).

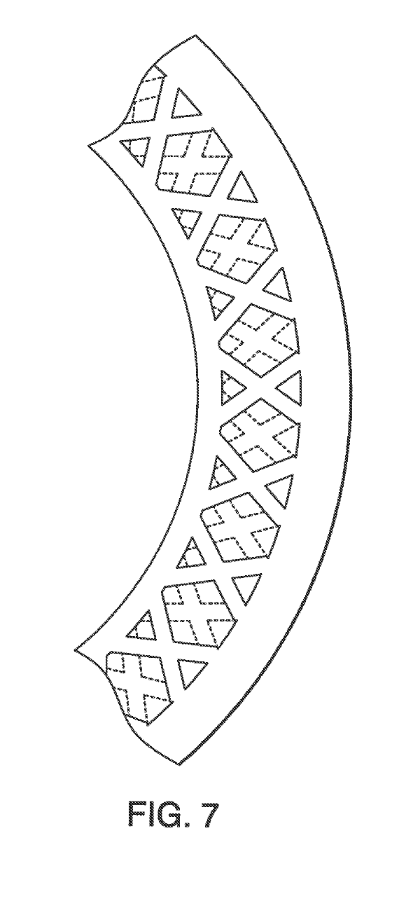

In another aspect of the present invention, there is provided a non-pneumatic tire sidewall, comprising: inner, middle and outer circumferential members; intersecting crossed spoke pair members connecting the circumferential members. On each sidewall, crossed spoke member pairs repeat for the entire circumference of tire. The spokes and cells on a sidewall may be offset or staggered relative to spokes on the opposing sidewall, FIG. 7. Alternatively, in certain embodiments, the spokes and cells on both sidewalls may also be aligned.

Preferably, the crossed spoke pair pattern is continuous around each sidewall of tire. The tire comprises two opposing sidewalls, each having a plurality of triangular shaped cells separated by spokes (4, 5, 7, 8). In a preferred embodiment triangular shaped cells, spokes (4,5,7,8), central web, inner circumferential web (3), middle circumferential web (2), outer circumferential web (1) and tread grooves (14) are molded in the same mold and are structurally integrated. As noted above, they may be molded of the same material throughout or they may be molded from multiple materials.

As shown in FIG. 2, cells (11), (12) and spokes (4, 5) extend in a radial direction from a center axis of tire. As used herein radially or radial refers to being in line with a direction that extends from the center axis of tire. As shown, radial cells (11, 12) have a substantially triangular shape.

The triangular cells (11, 12) on the sidewalls extend into the tire towards a central web (not shown). Often, the cells (11), (12) on one sidewall are staggered or offset relative to the cells on the other side of the central web. Likewise, the spokes (4, 5, 7, and 8) on one sidewall are staggered or offset relative to the crossed spokes on the opposing sidewall, which is located on the other side of the central web. Such staggering of cells and spokes reduces the amount of material used in the mold when making a tire of the present invention while maintaining desirable strength, durability and lifetime characteristics for the tire.

The number of cells and spoke pairs may vary depending on the configuration of tire. The tire may have, for example, from 5 to 60, typically from 10 to 60 crossed spoke pairs between the outer circumferential web and the middle circumferential web, or, for example, from 15 to 45 crossed spoke pairs between the outer circumferential web and the middle circumferential web on each sidewall. The tire may similarly have, for example, from 5 to 60, typically from 10 to 60 crossed spoke pairs between the middle circumferential web and the inner circumferential web, or for example, from 15 to 45 crossed spoke pairs between the middle circumferential web and the inner circumferential web on each sidewall.

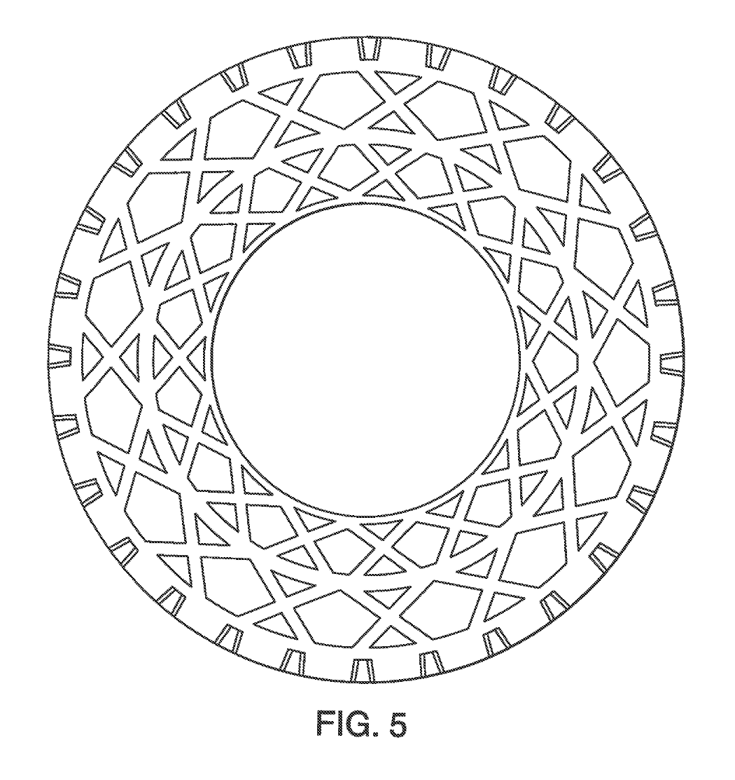

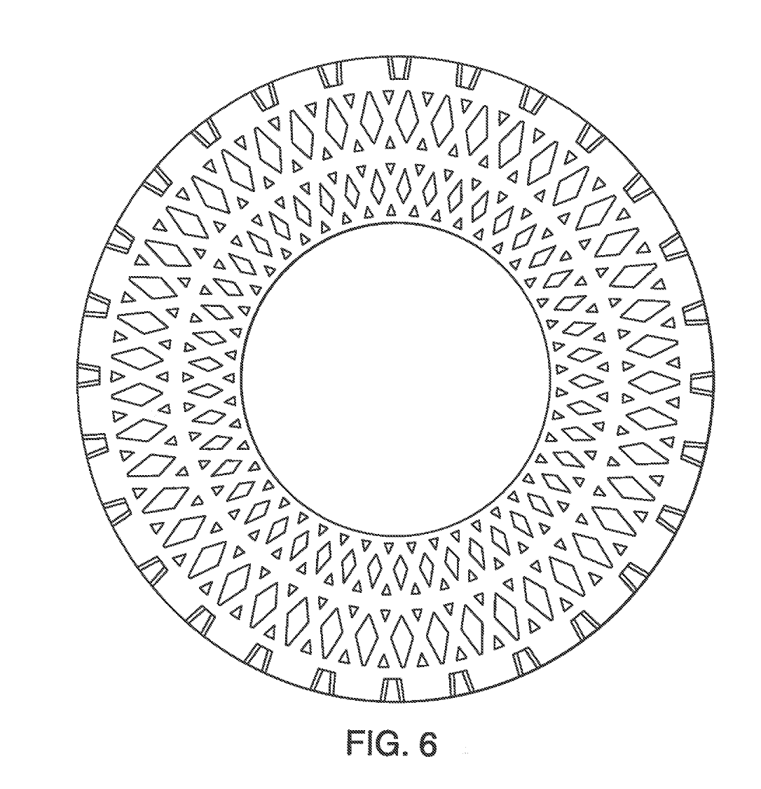

The crossed spoke pairs may be non-uniformly or uniformly spaced around the circumference of the tire. FIGS. 2-11 depict sidewalls of preferred embodiments of the present invention which incorporate approximately uniform spacing between the crossed spoke pairs. In contrast, it is also contemplated that the crossed spoke pairs may be spaced non-uniformly around the circumference of the tire (not shown). Tire size and end use will determine both the spoke thickness and the spacing of the crossed spoke pairs. For example, a tire such as the tire shown in FIG. 5 has an outer layer of 15 spoke pairs spaced uniformly about the circumference and an inner layer of 15 spoke pairs spaced uniformly about the circumference. A tire such as the tire shown in FIG. 6 has an outer layer of 45 crossed spoke pairs spaced uniformly about the circumference and an inner layer of 45 crossed spoke pairs spaced uniformly about the circumference. It is also contemplated that in embodiments with two layers of crossed spoke pairs, the outer layer may have more or less crossed spoke pairs than the inner layer. It is also contemplated that a tire may contain more than two layers of spoke pairs (not shown); the various spoke pair layers may have differing numbers of spoke pairs.

As indicated above, the tire of the invention typically includes a central web. The central web generally is oriented in an imaginary plane (the “radial plane”), which is perpendicular to the axis of rotation (the “central axis”) and centrally located relative to the sidewalls of the tire. Parallel to the axis of rotation, the tire has an inner circumferential member, a middle circumferential member and an outer circumferential member (in a two spoke layer tire) adjacent to each side of the central web. The central web connects the inner, middle and outer circumferential members, as well as provides a surface upon which the spokes on adjacent sidewalls of the central web are secured. Thus, the central web conceptually separates the spokes and cells on one lateral side of the tire from those on the other lateral side of the tire. That is, the central web preferably separates laterally opposing cells and laterally opposing spokes. The presence of a central web has been shown to significantly increase tire strength and tire lifetime.

In embodiments that contain a tread (14), the specific form or design of the tread may vary widely. The tread patter (if present) can also be varied around the tire or may also be evenly spaced around the tire. The tread may be formed on a separate structure which overlays the outer circumferential member, or as indicated above, the contact surface of the outer circumferential web (1) may contain a tread patter molded therein. A tread patter on the outside tire surface is often necessary for traction in wet or snow covered conditions. Referring now to FIGS. 5 and 6, the tread (14) is shown in a configuration that provides traction and structurally takes advantage of an embodiment of the spoke patterns. In a non-pneumatic spoke tire, the tread design influences the contact forces and interacts with the spokes in a manner that affects both force variation and durability.

If present, the tread is typically formed together with the sidewalls using the same materials and mold. In other embodiments, a tread (e.g., rubber) may be added to tires of the present invention. The tread (14) may be glued or otherwise adhered to the outer circumferential web member (1). As stated above, the tread pattern can also be inherently molded into the outer circumferential web member 1 as an integral part thereof. It can be readily appreciated that the surface of the tread may be chosen to accommodate the end use conditions of the tire. Embodiments of the present invention may be used with various conventionally known tread patterns.

The tires of the present invention may be molded from one material or they may be molded from different materials. For example, the entire tire may be composed of one material and molded in the same mold. In such cases all elements are structurally integrated. In certain embodiments fiber reinforcement may also be utilized. Alternatively, the spokes, which comprise the spoke members as described, and webs may be one material, and the tread may be a different material. Dual durometer construction can be very beneficial to wear, traction, cut/tear and abrasion properties. A dual or multiple durometer tire allows different hardness materials to be used throughout the structure of the tire as well as separate tread compounds. Numerous durometer materials may be utilized. For example, a high durometer material, e.g., 60 to 95 Shore A durometer, may be used for the spoke inner ends and a slightly lower durometer material, e.g., 50-90 Shore A durometer, may be used for the spoke outer ends. Alternatively, a high durometer material, e.g., 60 to 95 Shore A durometer may be used for the spoke outer ends and a slightly lower durometer material, e.g., 50-90 Shore A durometer, may be used for the spoke inner ends. Varying the durometer of the spoke ends allows for spokes design to control deflection and to provide specific properties at specific locations. Thus, a dual or multiple durometer tire would allow a tire design which suits a specific application. For example, in an application needing more cut/tear resistance, a tire could be molded with polyurethane spokes and webs and rubber for the treads.

In one embodiment, the tire is solid and has a unitary, i.e., integral, structure that comprises a tire and tread formed together and made of the same composition. A unitary structure is configured so that the web and crossed spoke pair structures provide a load-carrying structure with substantially uniform deformation due to compression of the tire as the tire rotates during operation.

The thickness of the webs and the spokes are matched such that there is very little to essentially no sidewall bulge of the tire during operation. In addition, the tire may deform without buckling, due to compression during normal operation, but the tire is configured to allow the spokes and webs to locally buckle, either individually or severally, when the tire runs over a projection on the ground. The word “buckle” as used herein is defined as a relatively sudden and radical deformation as a result of compression loading that exceeds a certain critical load value. In addition, the tires of the present invention tend to exhibit improved envelopment of road or other surface hazards relative to conventional solid non-pneumatic tires due to this buckling behavior resulting in reduced impact forces on the vehicle.

The dimensions of tire may be affected by various design parameters such as ground pressure (traction), vertical spring rate (ride), cornering power (handling), total deflection, material volume, and tire weight. The tire configurations having the spoke design of the present invention can be used with almost any size tire. In some selected embodiments, the tire configurations are found to be well-suited for tires having, for example:

an outer diameter that may range from 6 inches to 190 inches, e.g. from 8 inches to 159 inches, e.g., from 25 inches (64 cm) to 190 inches (483 cm), e.g. from 60 inches (152 cm) to 159 inches (404 cm) or from 63 inches (160 cm) to 100 inches (254 cm);

an inner diameter that may range from 2 inches (5 cm) to 170 inches (432 cm), e.g. from 30 inches (76 cm) to 110 inches (279 cm) or from 40 inches (102 cm) to 80 inches (203 cm); a tread width that may range from 1 inch (2.5 cm) to 70 inches (178 cm), e.g. from 20 inches (51 cm) to 59 inches (150 cm) or from 26 inches (66 cm) to 29 inches (74 cm).

The height of sidewall may range from 1 inch (2.5 cm) to 110 inches (279 cm), e.g. from 5 inches (13 cm) to 80 inches (203 cm) or from 15 inches (38 cm) to 50 inches (127 cm).

Each cell may have a depth ranging from 0.5 inches (1.3 cm) to 65 inches (165 cm), e.g. from 8 inches (20 cm) to 15 inches (38 cm) or from 10 inches (25 cm) to 13 inches (33 cm).

Each spoke may have a thickness ranging from 0.03 inches to 15 inches (38 cm), e.g. from 0.75 inches to 13 inches (33 cm) or from 2 inches (20 cm) to 11 inches (28 cm). Of course, the number of tire spoke layers and the thickness of the web members will also impact the selection of spoke thickness. In the embodiment where the spokes are staggered with respect to laterally opposing spokes, and the opposing cells are separated by a central web, there is a beneficial relationship between the spokes and the central web.

Depending on the size of the tire and the number of crossed spoke pairs in a given design, the thickness of the spokes can range in size from about 0.03 inches to 15 inches in thickness e.g. 0.1 inches to 10 inches or 0.4 inches to 6 inches per tire and the circumferential web thickness can range from 0.05 to 4 inches thick e.g. 0.1 to 3.5 inches or 0.4 to inches or 0.5 to 2.75 inches. For example, on a 12 foot tire the spoke thickness can range from 1 to 4 inches thick and the circumferential webs can be from 0.5 to 3 inches thick, whereas on a 10 inch tire the spoke thickness can range from 0.1 to 0.5 inches thick and the circumferential webs can be from 0.1 to 0.5 inches thick. The selection of spoke and web thickness would, of course, depend on the conditions of use and the particular material chosen. In one embodiment the width of the central web is less than the width of each spoke.

As mentioned above, the angle of the outer spoke members and/or the inner spoke members may be varied to suit the intended end use of the tire. Any angle suitable for the application may be used. In some embodiments, the outside spoke ends of the first and second outer crossed spoke members are angled, e.g., from 5 or 10 to 85 degrees, e.g., from 20 to 80 degrees, 30 to 85 degrees, 20 or 30 to 70 degrees, 30 or 35 to 55 or 60 degrees, 5 to 55 degrees, 35 to 80 degrees, etc., from the outer circumferential member, and the inside spoke ends of the first and second inner spoke members are angled from, e.g., from 10 to 85 degrees, e.g., from 20 to 80 degrees, 30 to 85 degrees, 20 or 30 to 70 degrees, 30 or 35 to 55 or 60 degrees, 5 to 55 degrees, 35 to 80 degrees, etc., from the middle circumferential member.

As noted above, for any given spoke, the spoke thickness can vary. For example, the inside spoke ends (9) may be thinner or thicker than the outside spoke ends (10). In some embodiments, all inside spoke ends on a tire are of the same thickness. In some embodiments, the inside spoke ends on a tire may be of different thicknesses. In some embodiments, all outside spoke ends on a tire are of the same thickness. In some embodiments, the outside spoke ends may be of differing thicknesses. Likewise, in embodiments with multiple spoke layers, the inside spoke ends on one layer may be thicker or thinner than the inside spoke ends on another layer. The outside spoke ends on one layer may be thicker or thinner than the outside spoke ends on another layer.

The synergy between the cells and the crossed spoke pairs allows parts of the tire to deflect more and carry more load than would otherwise be expected. In some embodiments, the tires of the invention are intended for use on OTR vehicles, and in particular embodiments, OTR tires of the invention are capable of supporting OTR vehicles with operational weights as high as 380 to 460 tons. An additional benefit of the invention is that the increased tire strength may allow for a reduction in the amount of tire material for a given load, which reduces the tire weight and maximizes material efficiency. Further, the improved strength in the tires of the present invention preferably provide increased tire lifetime relative to conventional pneumatic and non-pneumatic tires.

Certain tires of the present invention may support up to 200,000 lbs. per tire (91,000 kg per tire), e.g. 40,000 to 150,000 lbs. per tire (18,000 kg to 68,000 kg per tire) or 60,000 to 100,000 lbs. per tire (27,200 kg to 45,400 kg per tire). In one embodiment, a tire assembly of the present invention may support such weights on a vehicle when the vehicle is traveling at speeds up to 60 mph (97 km/hr) or higher, e.g. from 5 to 60 mph (8 to 97 km/hr), from 5 to 40 mph (8 to 97 km/hr 64 km/hr) or 20 to 30 mph (32 to 48 km/hr). Each of the tires in some embodiments may weigh approximately 500 lbs. (227 kg) to 15,000 lbs. (6,804 kg), e.g., 2,000 lbs. (907 kg) to 10,000 lbs. (4,535 kg) or 6,000 lbs. (2721 kg) to 8,000 lbs. (3,629 kg).

The tires of the present invention are non-pneumatic, meaning that the tires are made of a solid material that does not require inflation to be operational. Non-pneumatic tires do not have the risks associated with tire failures, blowouts, or punctures associated with pneumatic tires. An additional benefit of non-pneumatic tires is that even in the event of a tire failure, the tire may be driven on so that the vehicle, e.g., OTR vehicle, can be moved to a maintenance facility without requiring expensive or time-consuming towing.

As mentioned above, even though certain embodiments of the invention relate to large tires supporting heavy loads on OTR or other vehicles, other tires of the invention are intended for use on smaller vehicles and devices wherein lighter loads are encountered. The various characteristics of the inventive tire also provide advantages for these smaller load applications.

Suitable materials for non-pneumatic tires include polyurethane elastomers, which can be conveniently formed from appropriate commercially available prepolymers, for example, Adiprene™, Durocast™, and Vibrathane™ prepolymers, such as those in U.S. Pat. Nos. 4,832,098, 4,934,425, 4,921,029, 4,784,201, 5,605,657, and U.S. application Ser. No. 09/919,994, filed on Aug. 2, 2001, the relevant disclosures of which are hereby incorporated by reference. One exemplary material includes a polyurethane elastomer comprising a prepolymer formed from a diisocyanate and a polyol, e.g. polycaprolactone, polyester, poly(tetramethylene ether) glycol (PTMEG), etc., that is cured with diamine curative such as 4,4′-methylene-bis(2-chloroaniline) (MBCA); 4,4′-methylene-bis(3-chloro-2,6-diethylaniline (MCDEA); diethyl toluene diamine (DETDA; Ethacure™100 from Albemarle Corporation); tertiary butyl toluene diamine (TBTDA); dimethylthio-toluene diamine (Ethacure™300 from Albemarle Corporation); trimethylene glycol di-p-amino-benzoate (Vibracure™A157 from Chemtura Company, Inc. or Versalink™740M from Air Products and Chemicals); methylene bis orthochloroaniline (MOCA), methylene bis diethylanaline (MDEA); methylenedianiline (MDA); and MDA-sodium chloride complex (Caytur™ 21 and 31 from Chemtura Company). Exemplary elastomeric materials suitable for non-pneumatic tires include polyurethanes such as those formed from commercially available polyurethane prepolymers and Caytur™Mdiamine curatives from Chemtura Corp., a segmented copolyester such as HYTREL 5556 from DuPont, a reaction injection molded material, and a block copolymer of nylon such as NYRIM from Monsanto Chemical Co. In this disclosure, polyurethane refers to polymer with urethane linkages (derived from an isocyanate group and a hydroxyl group) and optionally, urea linkages as well (derived from an isocyanate group and an amine group). Examples of such polyurethane elastomers are disclosed in U.S. Pat. Nos. 5,077,371, 5,703,193, and 6,723,771, and U.S. application Ser. No. 11/702,787, filed on Feb. 5, 2007, the relevant disclosures of which are hereby incorporated by reference.

In one particular embodiment, the elastomeric material comprises a temperature de-blocked polyurethane elastomer formed from mixture of a polyurethane prepolymer formed from a polyol, e.g. polycaprolactone, polyester, poly(tetramethylene ether)glycol (PTMEG), etc., and a diphenylmethane diisocyanate (MDI), which may heave a low free MDI content from 0.1% to 7.0%, e.g., from 1.0% to 5.0% based on the total weight of the prepolymer mixture, and a blocked MDA curative, e.g. a coordination complex of a salt and MDA having a low free methylenedianiline (MDA) content, from 0.05% to 2.0%, e.g. from 0.1% to 1.0% based on the total weight of the curative, as described for example, in US Pat Publication No. 2003/0065124, the relevant disclosure of which is incorporated herein by reference. Suitable low free MDI polyurethane prepolymers include Adiprene™LFM 2450, Adiprene™LFM 2400, Adiprene™LFM 1250, Adiprene™LFM 500, and Vibrathanem8030 each made by Chemtura Corporation.

Suitable low free MDA curative includes Caytur™ 21, Caytur™21-DA, Caytur™31, Caytur™31-DA each made by Chemtura Corporation. Particularly useful polyurethane hot cast prepolymers for use in the tires of the present invention include Adiprene™, Vibrathane™ and Duracast™ prepolymers.

The tires described herein may be cast in a variety of manners, such as, for example, injection molding, spin cast molding or rotational molding. Rotational molding or rotational casting, more commonly known as rotomolding, is widely used for molding hollow articles, and can be used to mold tires according to the present invention. The process is relatively less expensive and easy to use for polymer processing than other known means and has been increasing in use.

To rotomold a part, polymeric resin, usually in powder, liquid or micropellet form, or combinations thereof, is charged inside a mold shell, which is then typically rotated on two axes and heated to cause the melting resin to adhere to the inside of the mold. After sufficient heating time, the mold is moved to a cooling chamber, and after cooling, the molded part is removed to begin another molding cycle. More detailed discussion of rotomolding may be found in Modern Plastics Encyclopedia, 1990, pp. 317-318, and in Encyclopedia of Polymer Science and Engineering, pp. 659-670, J. Wiley & Sons, 1990.

Injection molding is a process that typically occurs in a cyclical fashion. Cycle times generally range from 10 to 100 seconds and are controlled by the cooling time of the polymer or polymer blend used. In a typical injection molding cycle, polymer pellets or powder are fed from a hopper and melted in a reciprocating screw type injection molding machine. The screw in the machine rotates forward, filling a mold with melt and holding the melt under high pressure. As the melt cools in the mold and contracts, the machine adds more melt to the mold to compensate. Once the mold is filled, it is isolated from the injection unit and the melt cools and solidifies. The solidified part is ejected from the mold and the mold is then closed to prepare for the next injection of melt from the injection unit.

Certain processes of the present invention provide for molding a tire having an outside diameter of up to 190 inches (483 cm), which may require several tons of raw material or resin. As discussed above, a polyurethane elastomer comprising a low free MDI polyurethane prepolymer and a low free MDA curative can be particularly useful for preparing such a large tire, as well as smaller tires of the invention.

In one example, a process for preparing the tire of the present invention may comprise two charging stages for each material in the blend, and a molding stage. In the first charging stage, a drum containing low free MDI polyurethane prepolymer is melted at a temperature of from 30 to 70° C. for at least 18 hours prior to use. Note that while one drum is discussed for purposes of clarity, multiple drums may be used depending on the size of the tire to be produced and size of the drums. While melting the prepolymer, a drum of the low free MDA curative is placed on a tumbler for at least 12 hours. Once the drum of low free MDI polyurethane prepolymer is melted, the polyurethane prepolymer is pumped into a mixing vessel in a manner such that the exposure to air is minimized. Typically the mixing vessel has a pressure of about 50 mBar absolute or lower. The vacuum pressure may have to be restored when pumping the low free MDI polyurethane prepolymer into the mixing vessel. Once the first charging stage is completed, a pressure of 20 mBar or less is applied to the mixing vessel and the low free MDI polyurethane prepolymer may be allowed to stand until substantially all bubbling has ceased, e.g. about 30 minutes.

Next, in the second charging stage, the low free MDA curative is added to the mixing vessel. In this stage, the agitator of the mixing vessel should be operational to prevent an improper charging of the low free MDA curative. In one embodiment, the agitator should be operating at 50 rpm or greater. Improper loading of low free MDA curative may be exhibited by permanent white specks in the product. The low free MDA curative is added at a rate of about 4 kg/min to the mixing vessel under similar pressure as the first stage. The temperature of mixing vessel is typically about 25 to 65° C. during the second stage. Once the second charging stage is completed, a pressure of 20 mBar or less is applied to mixing vessel and the mixture of low free MDI prepolymer and low free MDA curative may be allowed to degas under vacuum and agitation until substantially all bubbling has ceased, e.g. about 1 hour. In one embodiment, the mixing forms a blend of the low free MDA curative and low free MDI polyurethane. In one embodiment of the present invention it is advantageous to achieve a maximum temperature of the blend without curing the blend prior to pouring the mold.

After the charging steps, the blend is poured into the mold that is kept at a temperature of about 25 to 65° C., and is often non-preheated. In some embodiments, release and bonding agents may be applied to different portions of the mold prior to adding the blend. The agitator is shut off and the mixture is filtered prior to being added to the mold. Once the mold is completely filled, the halves and/or plates of mold assembly are closed and clamped together. The mold temperature is raised to 100 to 150° C. for about 16 to 24 hours to fully cure the material. The mold is then opened and the tire is released. Alternately, the tire may be removed from the mold after approximately 4-8 hours at 100 to 150° C. depending on thickness and post cured at this temperature outside of the mold.

Various molds may be used to make the tires of the present invention.

### Examples

In one example, a tire of the invention is prepared according to one of the processes above using:

Adiprene™ LFM 2450 is a MDI terminated PCL prepolymer mixture having low free MDI content (typically 3.0%-4.0%) due to a monomer removal step in manufacture. The NCO content of the prepolymer is about 4.35% to 4.55% and the equivalent weight is about 923 to 966.

Adiprene™MLFM 2450 which is cured, e.g., with Caytur™ curatives, such as Caytur 31 and Caytur™M31-DA are blocked delayed action amine curatives, to yield a high performance 93-95 A elastomer, 59% rebound. AdipreneT™LFM 2450 is particularly suited for industrial non-pneumatic tires and wheels.

Caytur 31™ and Caytur™31-DA are blocked delayed action amine curatives for use primarily with isocyanate terminated urethane prepolymers comprising a complex of MDA and sodium chloride dispersed in a plasticizer (dioctyl phthalate in case of Caytur™31 and dioctyl adipate in case of Caytur™ 31-DA) and optionally a pigment. Caytur 31 has a very low free MDA content (typical <0.5%). At room temperature, such curatives are virtually non-reactive. However at temperatures of about 115° C.-160° C., the salt unblocks and the freed MDA reacts rapidly with the prepolymer to form a tough elastomer. Amine group concentration is 5.78% in Caytur 31 and Caytur 31-DA. Hence the equivalent weight is 244 for Caytur 31 and Caytur 31-DA.

in another example, Adiprene™LFM 2450 cured with Caytur™31DA is used to make a tire having a configuration similar to FIGS. 2-6.

### ELEMENTS LIST

The numeric labels in the figures relate to particular elements as follows:
(1) outer circumferential web
(2) middle circumferential web
(3) inner circumferential web
(4) first outer spoke member
(5) second outer spoke member
(6) spoke intersection
(7) first inner spoke member
(8) second inner spoke member
(9) inside spoke end
(10) outside spoke end
(11) outer triangular shaped cell
(12) middle triangular shaped cell
(13) triangular shaped cell
(14) tread
(15) triangular shaped cell

What is claimed:

1. A non-pneumatic tire rotatable about a central axis, said tire non-pneumatic tire having an annular elastomeric body comprising:
a central web,
and opposing sidewalls, each of said sidewalls comprising:
a middle circumferential web member,
an outer circumferential web member,
a plurality of first outer spoke members each of which is inclined at a selected angle from the outer circumferential member, and
a plurality of a second outer spoke members each of which is inclined at a selected angle from the outer circumferential member in a direction opposite from the first outer spoke members,
wherein each first outer spoke member intersects with a second outer spoke member at a spoke intersection between the middle circumferential web member and the outer circumferential web member, the angle of the spoke members between the spoke intersection and the middle circumferential member may be the same or different than the angle of the spoke members between the outer circumferential member to the spoke intersection, and the spoke members have a thickness between the spoke intersection and the middle circumferential member that may the same or be different than the thickness of the spoke members between the outer circumferential member to the spoke intersection.

2. The non-pneumatic tire according to claim 1, further comprising:
a plurality of first inner spoke members each of which is inclined at a selected angle from the middle circumferential member to an inner circumferential web member and
a plurality of second inner spoke members each of which is inclined at a selected angle from the middle circumferential web member to an inner circumferential web member and in a direction opposite from that of the first inner spoke members.

3. The non-pneumatic tire according to claim 2, wherein the first and second outer spoke members have a different thickness than the first and second inner spoke members.

4. The non-pneumatic tire according to claim 2, wherein each of the first and second outer spoke members have an inside spoke end located between the spoke intersection and the middle circumferential member and an outside spoke end located between the spoke intersection and the outer circumferential member and wherein the inside spoke ends of the first and second outer spoke members have a different thickness than the outside spoke ends of the first and second outer spoke members.

5. The non-pneumatic tire according to claim 2, wherein the first and second inner spoke members form a V pattern.

6. The non-pneumatic tire according to claim 2, comprising:
a central web,
and opposing sidewalls, each of said sidewalls comprising:
an inner circumferential web member,
a middle circumferential web member,
an outer circumferential web member,
a plurality of first and second outer spoke members, wherein each of the first outer spoke members is inclined at a selected angle from the outer circumferential member, and each of the second outer spoke members is inclined at a selected angle from the outer circumferential member in a direction opposite from that of the first outer spoke members, and wherein each first outer spoke member intersects with a second outer spoke member at a spoke intersection between the middle circumferential web member and the outer circumferential web member, wherein each of the first and second outer spoke members have an inside spoke end located between the spoke intersection and the middle circumferential member and an outside spoke end located between the spoke intersection and the outer circumferential member; and
a plurality of first and second inner spoke members wherein each of the first inner spoke members is inclined at a selected angle from the from the middle circumferential member to the inner circumferential web member and each of the second inner spoke members is inclined at a selected angle from the middle circumferential member to the inner circumferential web member in a direction opposite from that of the first inner spoke members, wherein each first inner spoke member intersects a second inner spoke member at a spoke intersection between the middle circumferential web member and the inner circumferential web member, wherein each of the first and second inner spoke members have an inside spoke end located between the spoke intersection and the middle circumferential member and an outer spoke end located between the spoke intersection and the inner circumferential member.

7. The non-pneumatic tire according to claim 6, wherein the first and second outer spoke members have a different thickness than the first and second inner spoke members.

8. The non-pneumatic tire according to claim 6 wherein the angle and/or thickness of the first and second outer spoke members between the spoke intersection and the middle circumferential member is different than the angle and/or thickness of the first and second outer spoke members between the outer circumferential member and the spoke intersection.

9. The non-pneumatic tire according to claim 6 wherein the angle and/or thickness of the first and second inner spoke members between the spoke intersection and the middle circumferential member is different than the angle and/or thickness of the first and second inner spoke members between the outer circumferential member and the spoke intersection.

10. The non-pneumatic tire according to claim 6, wherein the inside spoke ends of the first and second outer spoke members have a different thickness than the outside spoke ends of the first and second outer spoke members.

11. The non-pneumatic tire according to claim 6, wherein the inside spoke ends of the first and second inner spoke members have a different thickness than the outside spoke ends of the first and second inner spoke members.

12. The non-pneumatic tire according to claim 10, wherein the inside spoke ends of the first and second inner spoke members have a different thickness than the outside spoke ends of the first and second inner spoke members.

13. The non-pneumatic tire of claim 1, wherein tread grooves are adhered to, or embedded in the outer circumferential member.

14. The non-pneumatic tire of claim of claim 1, wherein tread grooves are molded into the outer circumferential member.

15. The non-pneumatic tire of claim 1, wherein the tire is made of polyurethane.

16. The non-pneumatic tire of claim of claim 1, wherein the tire is molded from at least two different durometer materials in the same mold.
